(19) United States
(12) Patent Application Publication
(10) Pub. No.: US 2026/0319809 A1
(43) Pub. Date: Oct. 15, 2026

(54) SYSTEM AND METHOD OF AGENTIC LIBRARY-BASED FLEXIBLE AUTO-SELECTION AND ORCHESTRATION OF PROCUREMENT AGENTS

(71) Applicant: Zycus Infotech Pvt Ltd, Mumbai (IN)

(72) Inventors: Tejit Mithal, Mumbai (IN); Pridhvi Kare, Mumbai (IN); Durga Prasad, Mumbai (IN); Shabeesh Balan, Mumbai (IN)

(21) Appl. No.: 19/632,346

(22) Filed: Mar. 29, 2026

(30) Foreign Application Priority Data
Mar. 29, 2025 (IN) 202521030609

(51) Int. Cl. G06F 9/445; G06F 3/04842

(52) U.S. Cl. CPC G06F 9/445; G06F 3/04842

(57) ABSTRACT

A system and method for automating procurement workflows through a dynamic library of AI-powered procurement agents, each designed to handle specific tasks within the procurement process. The system allows users to define procurement use cases, after which it automatically selects, sequences, and executes relevant agents to carry out tasks such as supplier selection, risk assessment, negotiation, contract creation, and signing. The intelligent agents work autonomously, optimizing procurement costs, reducing human intervention, and minimizing errors. Additionally, the system learns from past transactions to continually improve its performance. By supporting customizable workflows and integrating digital contract execution, the invention enables fully automated, efficient, and secure procurement cycles. The solution enhances decision-making through AI-driven optimization, providing organizations with a scalable and cost-effective approach to procurement.

### CROSS-REFERENCE TO RELATED APPLICATION

The instant application claims priority to Indian Patent Application Serial No. 202521030609 filed Mar. 29, 2025, the entire specification of which is expressly incorporated herein by reference.

### FIELD OF THE INVENTION

The present invention relates to a system and method of agentic library-based flexible auto-selection and orchestration of procurement agents. The present invention further relates to the system and method for leveraging a library of AI powered procurement agents to automate and optimize procurement workflows dynamically.

### BACKGROUND OF THE INVENTION

The procurement process is a critical function within organizations, influencing everything from cost management to supplier relationships. Traditionally, procurement workflows are manual and fragmented, often requiring significant human intervention across multiple stages. These stages include tasks such as supplier selection, bid evaluation, negotiation, contract creation, and finalization. Although technologies such as e-procurement and enterprise resource planning (ERP) systems have attempted to streamline these processes, inefficiencies remain due to the lack of dynamic automation and integration between various procurement tasks.

The existing problems in procurement software mainly include fragmented procurement workflows, inefficient decision-making, time-consuming negotiations and supplier selection, and limited adaptability to use cases. Traditional procurement software operates in silos, requiring manual intervention at multiple stages. Users need to navigate through different modules for supplier selection, risk assessment, negotiation, contract drafting, and signing. Each step requires separate user interactions, making the process cumbersome. Procurement professionals often make decisions based on incomplete information, requiring them to manually fetch data from various sources. For example, supplier risk analysis may not be seamlessly integrated with sourcing and bidding decisions, leading to inefficiencies.

Furthermore, users must manually evaluate suppliers, conduct price negotiations, and determine contract terms. Lack of automated orchestration between procurement stages results in delays and missed opportunities for cost savings. Traditional procurement solutions follow rigid workflows that do not adapt to different business scenarios. If a user wants to skip a step (e.g., supplier risk analysis), they need to manually configure the workflow, which is time-consuming.

In traditional procurement processes, organizations struggle with inefficiencies, manual interventions, and fragmented workflows, leading to higher costs, longer cycle times, and increased risks. Current procurement software lacks the ability to dynamically adjust workflows based on real-time business needs. Key challenges include:

Users must trigger all procurement activities in separate software systems, such as sourcing in sourcing management software and contract execution in contract management software, requiring them to switch between multiple systems.

Users must manually transfer procurement data from one software system to another, leading to errors and inefficiencies.

There is no single system that provides intelligent guidance on which software tools a user should leverage to achieve the best procurement outcomes.

Manual supplier selection and bid evaluation increase the risk of suboptimal procurement decisions.

Lack of automated risk intelligence during sourcing and negotiation leads to increased vulnerabilities.

Inefficient contract creation and management prolong the procurement cycle and introduce compliance risks.

Disjointed data flow across different procurement phases results in redundant work and inconsistencies.

High dependency on user intervention to coordinate procurement steps adds to operational inefficiencies and delays. In traditional procurement processes, organizations struggle with inefficiencies, manual interventions, and fragmented workflows, leading to higher costs, longer cycle times, and increased risks.

Current procurement software lacks the ability to dynamically adjust workflows based on real-time business needs. Key challenges include:
Manual supplier selection and bid evaluation
Lack of automated risk intelligence during sourcing and negotiation
Inefficient contract creation and management
Disjointed data flow across different procurement phases
High dependency on user intervention to coordinate procurement steps

U.S. Pat. No. 11,164,152 discusses a system and method including a computer-implemented method for autonomous procurement. User inputs defining a procurement request are received through a user interface. A pro forma contract is created, including performing a syntax analysis, a semantics analysis, and a pragmatic analysis on the user inputs to create a variables matrix of variables defining the pro forma contract. Bidders for the pro forma contract are selected, including creating a bidder list identifying suppliers who are to be invited to participate in bidding or submitting a quotation. A statement of work (SOW) is created based on the variables defining the pro forma contract. Solicitations of interest including the SOW are issued by the autonomous procurement system to bidders identified in the bidder list. Bidding parties are evaluated to identify qualified bidders. A winning bidder is selected from the bidding parties, and a final contract for the winning bidder is created.

### OBJECTS OF THE INVENTION

The primary object of the present invention is to provide a system and method of agentic library-based flexible auto-selection and orchestration of procurement agents.

Another object of the present invention is to provide a system for flexible auto-selection and orchestration of procurement agents that leverages a library of AI-powered procurement agents to automates and optimize procurement workflows dynamically.

Another object of the present invention is to provide a system that eliminates inefficiencies in traditional procurement processes by automatically selecting, sequencing, and executing procurement agents based on user-defined use cases.

Another object of the present invention is to provide a system for end-to-end automation of procurement tasks in which agents execute tasks autonomously thus reducing manual effort.

Another object of the present invention is to provide a system for inter-communication for seamless execution in which the entire process is automated and requires minimal human intervention.

Another object of the present invention is to provide a system for user-customizable workflows in which users can add, remove, or modify agents within the orchestration flow and allow for tailored procurement processes.

Another object of the present invention is to provide a system for enhanced decision making through AI-powered agents resulting in faster decision-making and improved procurement outcomes.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The invention, as described, addresses key inefficiencies and limitations of traditional procurement software by introducing an advanced, dynamic procurement orchestration system powered by AI-driven agents. Unlike conventional systems that operate in rigid, siloed workflows, this solution enables a flexible, agent-based approach to automate, streamline, and optimize procurement tasks, thus reducing manual intervention and improving operational efficiency.

According to an aspect of the present invention, the system comprises of a library of specialized procurement agents, each designed to autonomously perform a distinct task in the procurement lifecycle. These tasks range from supplier selection and risk analysis to contract negotiation, creation, and signing. The system dynamically selects and orchestrates these agents based on user-defined procurement use cases, enabling seamless execution across different procurement stages.

According to an aspect of the present invention, the system is designed to minimize human intervention, ensure efficient data flow, and enable seamless integration across all procurement stages. By utilizing machine learning and artificial intelligence, the system learns from past procurement processes and optimizes future workflows, ultimately resulting in cost savings, faster procurement cycles, and better risk management.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however, noted that the present invention is not limited to these embodiments, but rather the intention is that modifications that are apparent are also included.

This present invention relates to a system and method of agentic library based flexible auto-selection and orchestration of procurement agents. The invention describes a system for procurement automation that leverages a library of AI-powered procurement agents to dynamically orchestrate and execute procurement workflows based on user-defined use cases. Traditional procurement software suffers from fragmented workflows, inefficient decision-making, time-consuming negotiations, and limited adaptability. The present invention addresses these challenges by introducing a flexible procurement agentic orchestration system, which automates and optimizes procurement processes through the intelligent assembly and execution of specialized procurement agents.

The present invention addresses the existing technical challenges by offering a dynamic orchestration of agents, which reduces manual effort. The system automates supplier selection using AI and real-time data, ensuring more efficient and informed decision-making. Risk assessment is integrated seamlessly into sourcing and negotiation, allowing for a more comprehensive approach. AI-driven negotiation agents optimize pricing and terms, significantly improving cost savings. The entire contract management process-from creation to signing-is automated and integrated within the workflow, eliminating the need for separate systems. Furthermore, it allows for customizable workflows that adapt to different procurement use cases, offering flexibility where traditional systems fall short. The system provides full automation across procurement stages, minimizing the need for human oversight. Data flows seamlessly between agents, ensuring continuity and reducing errors. AI-powered agents analyze procurement data to optimize decisions, leading to faster procurement cycles with fewer delays. As a result, procurement costs are optimized, and the overall process is much more efficient compared to traditional systems.

According to the embodiment of the present invention, the system for flexible auto-selection and orchestration of procurement agents comprises of input unit, processing unit and output unit. The processing unit comprises:
1) A library of procurement agents, wherein each agent is pre-trained to perform a distinct procurement activity.
2) A user interface that allows a user to define a procurement use case.
3) A workflow orchestration module configured to:
   a) Dynamically select procurement agents from the library based on the user-defined use case.
   b) Sequence the selected agents in an execution flow.
   c) Execute the selected agents autonomously, wherein the output of each agent serves as input for the next agent.

According to the embodiment of the present invention, the method for automated procurement orchestration in brief involves the following steps:
Receiving a user-defined procurement request;
Selecting procurement agents;
Arranging agents into an execution flow;
User customization; and/or
Executing the procurement process.

According to the embodiment of the present invention, each agent is designed to operate independently while interacting seamlessly with other agents in a predefined workflow. For example, a Bid Collection Agent gathers bids from suppliers and passes the data to a Negotiation Agent, which then optimizes pricing and terms before forwarding it to a Contract Creation Agent. This modular approach allows the system to execute procurement processes dynamically and efficiently. These agents are dynamically configurable by the user, allowing for the creation of customized procurement workflows. The agentic approach enables the system to function with minimal human intervention, ensuring efficient procurement execution through a structured and automated orchestration of procurement processes.

According to the embodiment of the present invention, each agent is pre-trained on procurement-related tasks and capable of autonomous execution without human intervention. These agents are also interoperable, meaning they can receive input from preceding agents and provide output to subsequent agents in the workflow. This flexibility allows them to work together seamlessly in a continuous procurement process. Furthermore, these agents are customizable, enabling users to include or exclude them based on their specific business needs.

Examples of Procurement Agents in the Library:
1) Catalogue Selection Agent—Selects products based on user specifications.
2) Supplier Selection Agent—Shortlists suppliers based on procurement criteria.
3) Supplier Risk Analysis Agent—Evaluates supplier credibility, compliance, and risks.
4) Sourcing Agent—Facilitates the request for quotes (RFQ) and bid collection.
5) Supplier Negotiation Agent—Conducts AI-driven bid negotiations for optimal pricing.
6) Contract Creation Agent—Drafts procurement contracts with predefined legal terms.
7) Contract Signing Agent—Executes contracts digitally with e-signature integration.

According to the embodiment of the present invention, the method of flexible auto-selection and orchestration of procurement agents using agentic library consists of following steps:
1. User Input:

The user begins the process by defining the procurement use case. The input may also specify the need for tasks like sourcing, negotiating, creating a contract, and signing it. This defines the scope of the procurement. A user submits a procurement request through the input means or interface, specifying their needs (e.g., sourcing products, selecting suppliers, or negotiating contracts).

The system interprets the user input automatically, identifying the required tasks and determining the necessary agents to fulfil the request. Traditional procurement systems may require manual setup for each step, but the present invention does this process, making it much more efficient.
2. Agent Selection & Configuration:

Once a user defines a procurement use case through the software's user interface, the system automatically selects the appropriate agents from the procurement agentic library, aligning them to fulfil the specific procurement request. Each agent is responsible for executing specific tasks such as supplier selection, catalogue selection, or contract signing. The agents are tailored to the user's specific procurement needs. The system arranges the selected agents in a logical sequence based on the user's request. This step ensures that the agents operate in the correct order to complete the procurement process efficiently.

This step is crucial for automation. Instead of requiring manual configuration for each procurement process, the system automatically selects the most appropriate agents based on the request. This reduces setup time and human error, streamlining the entire workflow. This dynamic agent selection ensures that only the necessary agents are activated, optimizing system efficiency.
3. Workflow Orchestration by the workflow orchestration module:

At this stage, the workflow orchestration module of the system orchestrates the procurement workflow, ensuring that agents perform their tasks in a predefined or dynamically configured order based on the user's needs. The user can modify the workflow by adding, removing, or rearranging the agents. This customization allows the user to tailor the process to their specific needs or business requirements. For example, if supplier risk analysis is not needed, the user can exclude the Supplier Risk Analysis Agent from the workflow.
4. Execution of the procurement process:

The system finally executes the procurement process autonomously, where each agent processes input data and generates output data for the next agent. Each agent processes its input data (e.g., supplier information, bids, etc.) and passes the output data to the next agent, ensuring a seamless and efficient flow across the procurement stages.

According to the embodiment of the present invention, there is seamless execution and data flow between agent. Each agent works in a chain-like execution model, where the output of one agent serves as input for the next agent in the workflow. The entire method is executed autonomously, requiring minimal human intervention. The system also learns from past transactions to optimize future procurement processes.

### Advantages

The system allows for seamless execution that ensures that each stage of the procurement lifecycle is connected and flows effortlessly from one phase to the next. The entire procurement process is fully automated, with minimal human intervention required. Once the user defines the procurement need, the system orchestrates each agent in sequence without requiring manual oversight. End-to-end automation ensures that the procurement process is fast, efficient, and error-free. This minimizes human input, reducing operational overhead and allowing procurement professionals to focus on higher-value tasks. It also helps organizations to scale their procurement operations with minimal additional effort. The system uses historical procurement data, supplier performance metrics, and market trends to continuously optimize decisions throughout the procurement process. The AI-driven optimization ensures that each agent is making decisions based on the most up-to-date and relevant data. For example, when negotiating with suppliers, the system considers historical pricing data, supplier performance, and other factors to ensure the best possible outcome. This decision-making process is dynamic, constantly evolving to ensure better results over time.

### Example

A user inputs a request: “I need to procure laptops with specific configurations from US suppliers, conduct a small sourcing event, negotiate bids for the best price, finalize contract terms, and sign the contract.” For agent selection and orchestration, the system dynamically picks and sequences the required agents:
1) Catalogue Selection Agent-Identifies laptops that match user specifications.
2) Supplier Selection Agent—Shortlists US-based suppliers for laptops.
3) Supplier Risk Analysis Agent—Analyses supplier compliance and risks.
4) Sourcing Agent—Initiates RFQ and collects bids from selected suppliers.
5) Supplier Negotiation Agent—Conducts negotiations to optimize pricing.
6) Contract Creation Agent—Drafts the procurement contract.
7) Contract Signing Agent—Facilitates the final contract signing.

The user can customize the orchestration by adding or removing agents. For example, if supplier risk analysis is not needed, the user can exclude the Supplier Risk Analysis Agent from the workflow.

While considerable emphasis has been placed herein on the specific elements of the preferred embodiment, it will be appreciated that various modifications and adaptations can be made without departing from the principles of the invention. These and other refinements in the preferred embodiments will be apparent to those skilled in the art from the disclosure herein. The foregoing description is to be interpreted as illustrative rather than limiting the scope of the present invention.

What is claimed is:

1. A system and method of agentic library-based flexible auto-selection and orchestration of procurement agents, characterised in that:
the system for flexible auto-selection and orchestration of procurement agents comprising an input unit, processing unit and output unit and the processing unit comprises:
a library of procurement agents, wherein each agent is pre-trained to perform a distinct procurement activity;
a user interface that allows a user to define a procurement use case;
a workflow orchestration module configured to dynamically select procurement agents from the library based on the user-defined use case, sequence the selected agents in an execution flow and execute the selected agents autonomously, wherein the output of each agent serves as input for the next agent;
wherein the system is operable to execute the steps of:
receiving a user-defined procurement request through an interface;
selecting appropriate procurement agents from a library, wherein each agent is trained to perform a distinct procurement function;
arranging the selected agents into an execution flow based on the user's procurement request;
enabling the user to modify the selected agents by adding or removing agents from the workflow;
executing the procurement process autonomously, where each agent processes input data and generates output data for the next agent.

2. The system as claimed in claim 1, wherein the procurement agents comprise:
a catalogue selection agent for identifying products based on user requirements;
a supplier selection agent for shortlisting suppliers;
a supplier risk analysis agent for evaluating supplier credibility;
a sourcing agent for conducting RFQ processes;
a supplier negotiation agent for optimizing procurement costs through AI-based negotiations;
a contract creation agent for drafting procurement contracts; and
a contract signing agent for finalizing agreements.

3. The system as claimed in claim 1, wherein the procurement agents exchange data autonomously without human intervention.

4. The system as claimed in claim 1, wherein the procurement agents are AI-driven and improve performance over time through machine learning.

5. The system as claimed in claim 1, wherein the user can add, remove, or rearrange agents in the workflow before execution.

6. The system as claimed in claim 1, wherein the workflow orchestration module learns from past procurement workflows to recommend optimized agent sequences for future transactions.

7. The system as claimed in claim 1, wherein the contract signing agent integrates with third-party e-signature platforms for digital contract execution.
